(19) United States
(12) Patent Application Publication
(10) Pub. No.: US 2008/0244680 A1
(43) Pub. Date: Oct. 2, 2008

(54) CONNECTION STATUS CHECKING APPARATUS AND CONNECTION STATUS CHECKING METHOD

(75) Inventor: Kiyoshi Mochizuki, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 12/037,405

(22) Filed: Feb. 26, 2008

(30) Foreign Application Priority Data
Mar. 30, 2007 (JP) 2007-090380

(51) Int. Cl. H04N 7/173

(52) U.S. Cl. 725/133

(57) ABSTRACT

According to one embodiment, a connection status checking apparatus checking a connection status of an external apparatus has following respective configurations. That is, the connection status checking apparatus includes: a connection part to which the external apparatus is connected; a command output unit outputting a check command for checking whether or not the external apparatus is connected to the connection part; a judging unit judging whether or not an answer to the check command from the external apparatus to which the check command is outputted by the command output unit exists; and a connection determining unit determining whether or not the external apparatus is connected to the connection part based on a judgment result of the judging unit.

### CROSS-REFERENCE TO RELATED APPLICATIONS

This application is based upon and claims the benefit of priority from Japanese Patent Application No. 2007-90380, filed Mar. 30, 2007, the entire contents of which are incorporated herein by reference.

### BACKGROUND

1. Field

One embodiment of the invention relates to a connection status checking apparatus and connection status checking method applied to a broadcast receiving apparatus such as a television, a tuner and an STB.

2. Description of the Related Art

Conventionally, there is known a broadcast receiving apparatus receiving a broadcast wave to reproduce a video signal, such as a television, a tuner, and an STB. There is also known a video reproducing apparatus reading digital data recorded in a recording medium such as a DVD (Digital Versatile Disk) and an HDD (Hard Disk Drive) to reproduce a video signal, and a video recording apparatus recording a video signal in a recording medium.

The conventional broadcast receiving apparatus is connected to an external apparatus such as the video reproducing apparatus or the video recording apparatus, and video is displayed by using a video signal outputted from the external apparatus.

Incidentally, a DVI (Digital Visual Interface) standard is widespread as a standard for transmitting a video signal. Recently, as a digital signal transmission standard further improved from the DVI standard, an HDMI (High Definition Multimedia Interface) standard has come to be adopted.

In the HDMI standard are included various specifications which the DVI standard does not have, such as being capable of multiplexing a digital sound signal during a blanking period of the digital video signal to transmit sound, being capable of transmitting the digital video signal in a color difference YCbCr form in addition to in an R,G,B form, and being capable of connection by a small HDMI connector similar to a USB (Universal Serial BUS), for example.

Meanwhile, recently, there are increasing occasions of constructing a home network in which an external apparatus such as a video display apparatus or a video reproducing apparatus is connected to a broadcast receiving apparatus. With regard to such a network, there is conventionally a technology to reduce traffic of the entire network by identifying the apparatus to be controlled among a plurality of external apparatuses in the network and making a state obtaining time period changeable, as disclosed in Japanese Patent Application Publication (KOKAI) No. 2005-5951 (Patent Document 1).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a configuration of a connection status checking system according to an embodiment of the invention;

FIG. 2 is an exemplary block diagram showing a configuration of a network system in the embodiment;

FIG. 3 is an exemplary block diagram showing a main configuration of the inside of a digital broadcast receiving apparatus in the embodiment;

FIG. 4 is an exemplary diagram schematically showing a part concerning HDMI communication of a second HDMI terminal and an external apparatus in the embodiment;

FIG. 5 is an exemplary flowchart showing a procedure of a main loop operation in a power standby state of a digital broadcast receiving apparatus in the embodiment;

FIG. 6 is an exemplary flowchart showing a procedure of a connection status checking operation in a digital broadcast receiving apparatus in the embodiment;

FIG. 7 is an exemplary block diagram showing a configuration of another connection status checking system in the embodiment;

FIG. 8(A) to FIG. 8(E) are exemplary views schematically showing checking patterns of connection statuses, FIG. 8(A) showing a type in which check commands are sequentially transmitted to every external apparatus during a check time period t. FIG. 8(B) shows a type in which check time periods t1, t2 are set so that a quiescent time period t0 is secured therebetween, check commands being sequentially transmitted to external apparatus in a first half of logical addresses during the check time period t1, and check commands being sequentially transmitted to external apparatus in a latter half of logical addresses during the check time period t2. FIG. 8(C) shows a type in which check time periods t1, t2 are set so that a quiescent time period t0 is secured therebetween, and check commands are transmitted to alternate external apparatuses during the check time periods t1 and during the check time periods t2. FIG. 8(D) shows a type in which the number of external apparatuses to which check commands are transmitted is different between a check time period t1 and a check time period t2. FIG. 8(E) shows a type in which check time periods t1, t2, t3 are set so that quiescent time periods t0 are secured therebetween in the embodiment; and

FIG. 9 is an exemplary diagram showing an example of an address list in the embodiment.

### DETAILED DESCRIPTION

Various embodiments according to the invention will be described hereinafter with reference to the accompanying drawings. In general, according to one embodiment of the invention, a connection status checking apparatus checking a connection status of an external apparatus has following respective configurations. That is, the connection status checking apparatus includes: a connection part to which the external apparatus is connected; a command output unit outputting a check command for checking whether or not the external apparatus is connected to the connection part; a judging unit judging whether or not an answer to the check command from the external apparatus to which the check command is outputted by the command output unit exists; and a connection determining unit determining whether or not the external apparatus is connected to the connection part based on a judgment result of the judging unit.

In a connection status checking method for checking a connection status of an external apparatus, the connection status is checked as follows. That is, the method includes: outputting a check command for checking whether or not the external apparatus is connected; judging whether or not an answer to the check command from the eternal apparatus to which the check command is outputted exists; and determining whether or not the external apparatus is connected to a connection part based on a judgment result of the judging.

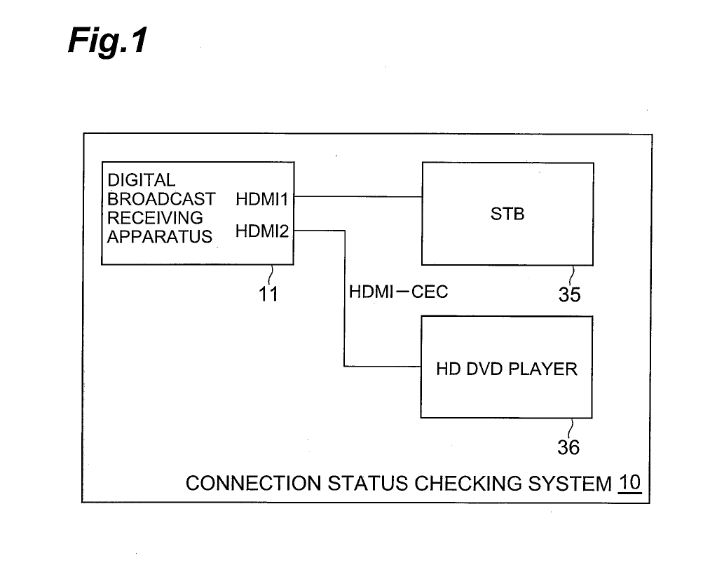

FIG. 1 is a block diagram showing a configuration of a connection status checking system 10 according to an embodiment of the invention. The connection status checking system 10 includes a digital broadcast receiving apparatus 11, an STB (Set-Top Box) 35 and a later-described HD DVD player 36 as external apparatuses connected to the digital broadcast receiving apparatus 11.

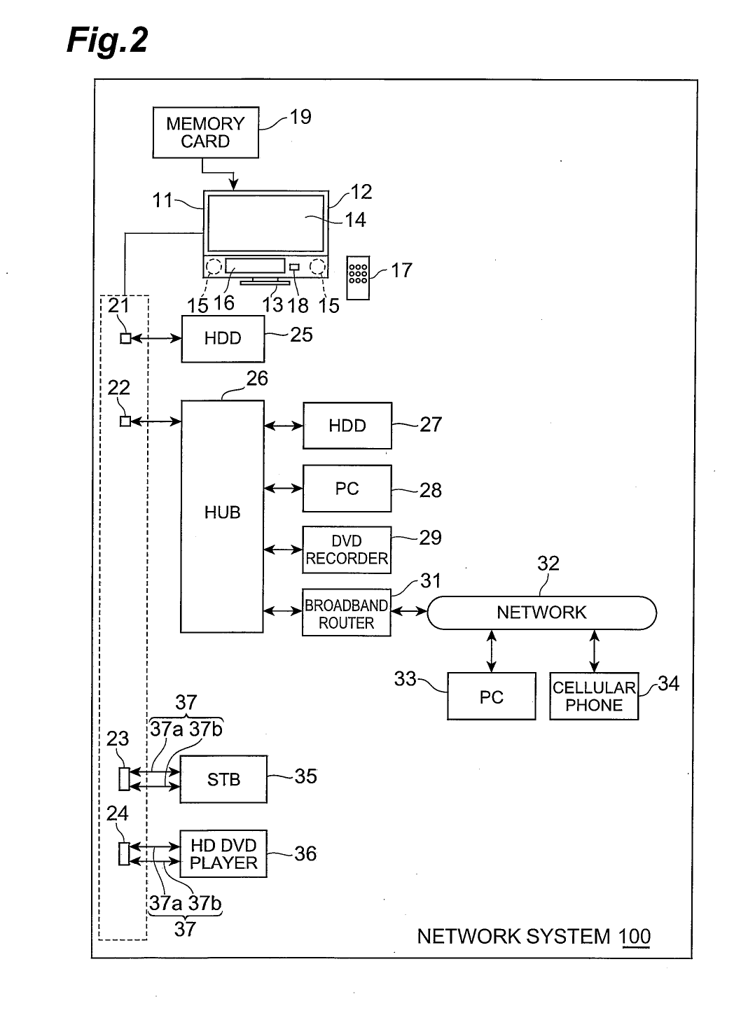

Next, FIG. 2 is a block diagram showing a configuration of the digital broadcast receiving apparatus 11 and a network system 100 configured centering on the digital broadcast receiving apparatus 11.

The digital broadcast receiving apparatus 11 includes a cabinet 12 and a support table 13 supporting the cabinet 12 with the cabinet 12 raised, as shown in FIG. 2. The cabinet 12 includes a flat panel type liquid crystal display apparatus 14 having a liquid crystal display panel, a speaker 15 as a sound output unit outputting sound, and an operation part 16, and also includes a light receiving part 18 receiving operation information transmitted from a remote controller 17.

The digital broadcast receiving apparatus 11 is a video display apparatus displaying video by the liquid crystal display apparatus 14 as a display unit displaying video, and displays video by using a video signal inputted from the STB 35 or the HD DVD player 36.

A memory card 19 such as an SD (Secure Digital) memory card, an MMC (Multi Media Card) or a USB memory, for example, is attachable and detachable to and from the digital broadcast receiving apparatus 11, and recording and reproducing of a program, a photograph and the like are performed by using the memory card 19.

The digital broadcast receiving apparatus 11 includes a first LAN (Local Area Network) terminal 21, a second LAN (Local Area Network) terminal 22, a first HDMI (High-Definition Multimedia Interface) terminal 23 (“HDMI 1” in FIG. 1), and a second HDMI (High-Definition Multimedia Interface) terminal 24 (“HDMI 2” in FIG. 1).

These terminals are selected in correspondence with apparatus switching, and the external apparatus connected to the selected terminal is set to be the external apparatus for video display. For example, when the first HDMI terminal 23 is selected by the apparatus switching, the STB 35 is set to be the external apparatus for video display.

The first LAN terminal 21 is used as a LAN compatible HDD exclusive port. This first LAN terminal 21 is used for recording and reproducing information by Ethernet (registered trademark) to and from a LAN compatible HDD (Hard Disk Drive) 25 connected to the first LAN terminal 21 as a NAS (Network Attached Storage).

As stated above, in the network system 100, by providing the first LAN terminal 21 as the LAN compatible HDD exclusive port, information recording of a program to the HDD 25 in high definition quality can be stably performed without being influenced by the other network environment, a network usage status and the like.

The second LAN terminal 22 is used as a general LAN compatible port using Ethernet. Equipment such as a LAN compatible HDD 27, a PC (Personal Computer) 28 and a DVD (Digital Versatile Disk) recorder 29 with a built-in HDD are connected to this second LAN terminal 22 through a hub 26, for example, and the second LAN terminal 22 is used for performing information transmission to and from such equipment.

Further, a PC 33 and a cellular phone 34 are connected to the second LAN terminal 22 through a broadband router 31 connected to the hub 26, and a network 32 such as the Internet, and the second LAN terminal 22 is also used for performing information transmission to and from the PC 33 and the cellular phone 34.

The first and second HDMI terminals 23, 24 are terminals for inputting high definition digital video signal and digital sound signal from the external apparatus in accordance with an HDMI standard. The STB 35 is connected as the external apparatus to the first HDMI terminal 23, while the HD DVD player 36 is connected to the second HDMI terminal 24. The first and second HDMI terminals 23, 24 have functions as connection parts to which the external apparatuses are connected.

The digital video signals and the digital sound signals are inputted and outputted between the first and second HDMI terminals 23, 24 and the external apparatuses through data lines 37a of HDMI cables 37. Further, to and from the first and second HDMI terminals 23, 24, there are inputted and outputted data for realizing various control functions in the digital broadcast receiving apparatus 11 and the external apparatus, through CEC lines 37b.

The STB 35 is connected to an unshown cable TV network to receive a program, or connected to an unshown telephone line to perform Internet connection. The STB 35 outputs the video signal to the digital broadcast receiving apparatus 11 through the HDMI cable 37.

The HD DVD player 36 performs reproduction of video in accordance with an HD DVD (High Definition DVD) standard. The HD DVD player 36 outputs the reproduced video signal to the digital broadcast receiving apparatus 11 through the HDMI cable 37.

The digital broadcast receiving apparatus 11 can input therein video signals, sound signals and control signals in digital forms by the first and second HDMI terminals 23, 24. The first and second HDMI terminals 23, 24 have functions as connection parts to which the external apparatuses are connected.

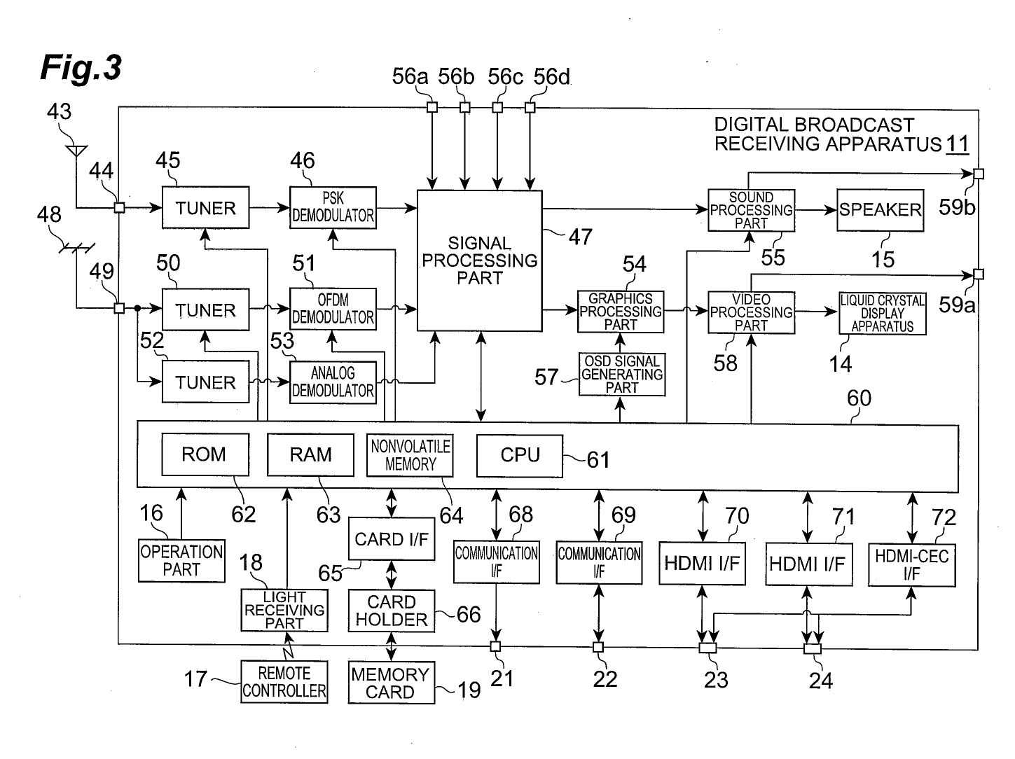

Next, a configuration of the inside of the digital broadcast receiving apparatus 11 will be described with reference to FIG. 3. FIG. 3 is a block diagram showing a main configuration of the inside of the digital broadcast receiving apparatus 11.

The digital broadcast receiving apparatus 11 includes input terminals 44, 49, tuners 45, 50, 52, and a PSK (Phase Shift Keying) demodulator 46. The digital broadcast receiving apparatus 11 also includes a signal processing part 47, an OFDM (Orthogonal Frequency Division Multiplexing) demodulator 51, an analog demodulator 53, a graphics processing part 54, a sound processing part 55, an OSD signal generating part 57 and a video processing part 58.

A satellite digital broadcast signal received by a BS/CS digital broadcast receiving antenna 43 is inputted to the input terminal 44. The satellite digital broadcast signal is supplied to the tuner 45 from the input terminal 44. The tuner 45 is a tuner for a satellite digital broadcast, and selects a broadcast signal of a desired channel from the satellite digital broadcast signals supplied thereto.

The broadcast signal which is selected by the tuner 45 is supplied to the PSK demodulator 46. The PSK demodulator 46 performs a demodulation processing of digital video signal and sound signal, and output the digital video signal and sound signal to the signal processing part 47.

A terrestrial digital broadcast signal received by a terrestrial broadcast receiving antenna 48 is inputted to the input terminal 49. The terrestrial digital, broadcast signal is supplied to the tuner 50 from the input terminal 49. The tuner 50 is a tuner for a terrestrial digital broadcast, and selects a broadcast signal of a desired channel from the terrestrial digital broadcast signals supplied thereto.

The broadcast signal selected by the tuner 50 is supplied to the OFDM demodulator 51. The OFDM demodulator 51 performs a demodulation processing of digital video signal and sound signal, and outputs the digital video signal and sound signal to the signal processing part 47.

A terrestrial analogue broadcast signal received by the terrestrial broadcast receiving antenna 48 is also inputted to the input terminal 49. The terrestrial analogue broadcast signal is supplied to the tuner 52 from the input terminal 49. The tuner 52 is a tuner for a terrestrial analogue broadcast, and selects a broadcast signal of a desired channel from the terrestrial analogue broadcast signals supplied thereto.

The broadcast signal selected by the tuner 52 is supplied to the analogue demodulator 53. The analogue demodulator 53 performs a demodulation processing of analogue video signal and sound signal, and outputs the analogue video signal and sound signal to the signal processing part 47.

The signal processing part 47 selectively applies a predetermined digital signal processing to the digital video signal and sound signal supplied respectively from the PSK demodulator 46 and the OFDM demodulator 51, and outputs the digital video signal and sound signal to the graphics processing part 54 and the sound processing part 55.

A plurality (four in the case of the illustration) of input terminals 56a, 56b, 56c, 56d are connected to the signal processing part 47. These input terminals 56a to 56d are capable of inputting analogue video signals and sound signals therein from the DVD recorder 29 and the like as the external apparatuses.

This signal processing part 47 selectively digitizes the analogue video signals and sound signals supplied respectively from the analogue demodulator 53 and the respective input terminals 56a to 56d. The signal processing part 47 applies predetermined digital signal processings to the digitized video signals and sound signals, and thereafter, outputs the digitized video signals and sound signals to the graphics processing part 54 and the sound processing part 55.

The graphics processing part 54 superimposes an OSD (On Screen Display) signal generated in the OSD signal generating part 57 on the digital video signal supplied from the signal processing part 47, and outputs the superimposed signal. The graphics processing part 54 can selectively output the output video signal of the signal processing part 47 and the OSD signal outputted by the OSD signal generating part 57, and also can combine and output both the outputs so that both the outputs constitute halves of the screen respectively.

The digital video signal outputted from the graphics processing part 54 is supplied to the video processing part 58. The video processing part 58 converts the inputted digital video signal to an analogue video signal in a format displayable in the liquid crystal display apparatus 14, and thereafter, outputs the analog video signal to the liquid crystal display apparatus 14. The video processing part 58 also leads the analogue video signal to the outside through an output terminal 59a.

The sound processing part 55 converts the inputted digital sound signal to an analogue sound signal in a format reproducible in the speaker 15, and thereafter, outputs the analogue sound signal to the speaker 15. The sound processing part 55 also leads the analogue sound signal to the outside through an output terminal 59b.

The digital broadcast receiving apparatus 11 includes a control part 60, a card holder 66 and various kinds of interfaces (card I/F 65, communication I/F 68, communication I/F 69, first HDMI I/F 70, second HDMI I/F 71, HDMI-CEC I/F 72).

The control part 60 includes a CPU (Central Processing Unit) 61, a ROM (Read Only Memory) 62, a RAM (Random Access Memory) 63 and a nonvolatile memory 64. The control part 60 comprehensively controls the operations of the digital broadcast receiving apparatus 11 including an operation of receiving the broadcast signal. The control part 60 receives operation information from the operation part 16, or receives operation information sent out from the remote controller 17 through the light receiving part 18, and controls each part so that an operation content thereof is reflected.

While the CPU 61 operates as various kinds of units (command output unit, judging unit, connection determining unit, operation control unit, apparatus list generating unit, apparatus list update unit, command generating unit, and display control unit) in accordance with a program stored in the ROM 62, the CPU 61 performs input and output of the signal from and to other components to perform operation control of the entire digital broadcast receiving apparatus 11.

The ROM 62 mainly stores a control program executed by the CPU 61. The RAM 63 provides a work area to the CPU 61. The nonvolatile memory 64 stores various kinds of setting information, control information and the like.

The control part 60 is connected to the card holder 66, to which the memory card 19 is loadable, through the card I/F (Interface) 65. Thereby, the control part 60 can perform information transmission to and from the memory card 19 loaded to the card holder 66 through the card I/F 65.

The control part 60 is also connected to the first LAN terminal 21 through the communication I/F 68. Thereby, the control part 60 can perform information transmission to and from the LAN compatible HDD 25 connected to the first LAN terminal 21, through the communication I/F 68. In this case, the control part 60 has a DHCP (Dynamic Host Configuration Protocol) server function, and assigns an IP (Internet Protocol) address to the LAN compatible HDD 25 connected to the LAN terminal 21 to perform control.

The control part 60 is connected to the second LAN terminal 22 through the communication I/F 69. Thereby, the control part 60 can perform information transmission to and from each apparatus connected to the second LAN terminal 22 such as the HDD 27, through the communication I/F 69.

The control part 60 is connected to the first HDMI terminal 23 through the first HDMI I/F 70 and the HDMI-CEC I/F 72, and connected to the second HDMI terminal 24 through the second HDMI I/F 71 and the HDMI-CEC I/F 72. Thereby, the control part 60 can perform information transmission to and from the STB 35 and the HD DVD player 36 which are connected to the first and second HDMI terminals 23, 24, through the first and second HDMI I/F 70, 71 and the HDMI-CEC I/F 72. The HDMI-CEC I/F 72 performs communication in accordance with the HDMI-CEC standard.

### Description of Operation Content

Next, there will be described an operation content of the connection status checking system 10 at a time that the digital broadcast receiving apparatus 11 having the above configuration performs connection status checking.

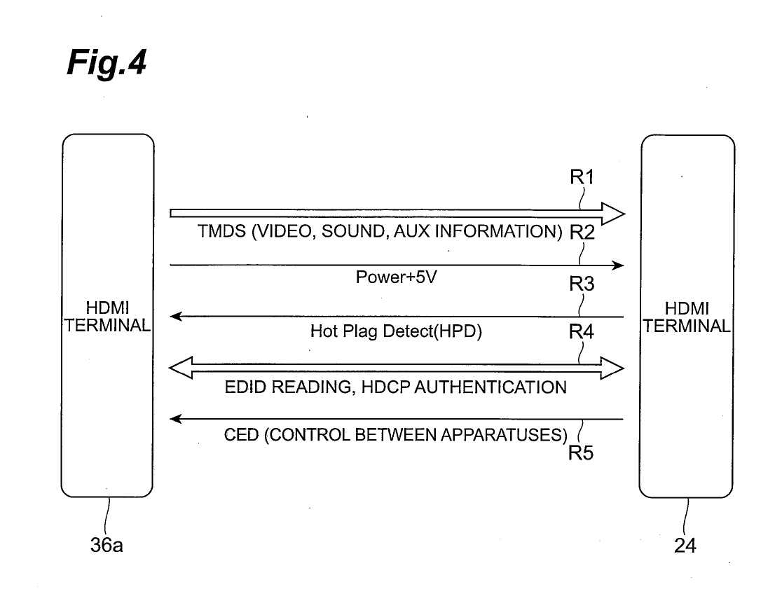

Here, FIG. 4 is a diagram schematically showing a part concerning communication (HDMI communication) compliant with the HDMI standard in the second HDMI terminal 24 of the digital broadcast receiving apparatus 11 and the HDMI terminal 36a of the DVD player 36 as the external apparatus.

In order that connection between the digital broadcast receiving apparatus 11 and the HD DVD player 36 is established, first, a power supply R2 of 5v is performed from the HD DVD player 36 to the digital broadcast receiving apparatus 11.

On detecting the power supply R2 of 5v, the digital broadcast receiving apparatus 11 changes a terminal level R3 of HPD (Hot Plug detect) from “Low” to “High”. Then, an initial state in which HDMI communication should be established is completed.

Next, the digital broadcast receiving apparatus 11 and the HD DVD player 36 performs reading of EDID (Extended Display Identification Data) and an authentication R4 of HDCP (High-bandwidth Digital Content Protection) by using a DDC (Display Data Channel) terminal.

When the reading of EDID and the authentication R4 of HDCP are completed, there is performed a data transmission R1 of the video signal, the sound signal, AUX information or the like from the HD DVD player 36 to the digital broadcast receiving apparatus 11, by using a TMDS (Transition Minimized Differential Signaling) terminal. The above R1 to R4 are performed through the HDMI I/Fs 70, 71.

When the above HDMI communication is established, the digital broadcast receiving apparatus 11 and the HD DVD player 36 perform an exchange of commands (command transmission/reception) R5 in accordance with a later-described procedure through the CEC line 37b. The digital broadcast receiving apparatus 11 performs control and connection status checking of the connected external apparatus by the command transmission/reception R5. The command transmission/reception R5 is performed through the HDMI-CEC I/F 72.

By the CPU 61 performing an operation as the operation control unit, the digital broadcast receiving apparatus 11 performs control so that the connection status checking is performed when a power source is in a standby state (a state that a main power source is not turned on, also referred to as a power off state).

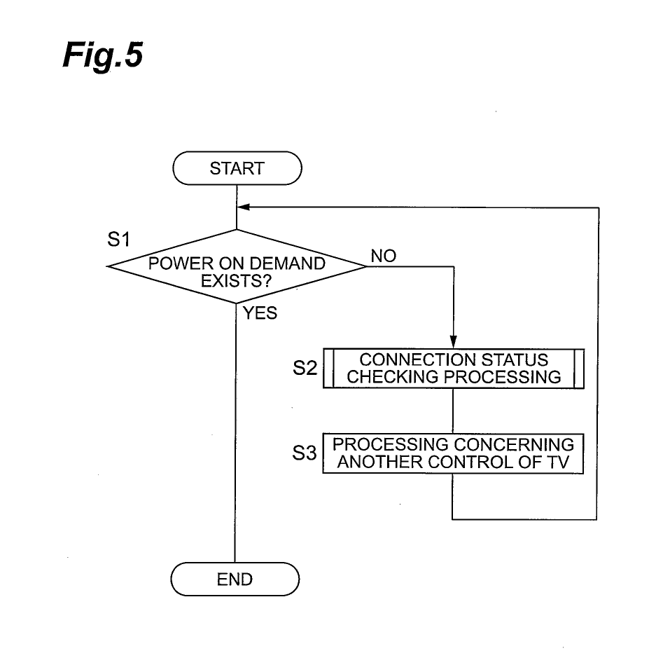

The digital broadcast receiving apparatus 11 repeatedly performs a main loop operation constituted by S1 to S4 according to a flowchart shown in FIG. 5, in a power standby state. Here, FIG. 5 is a flowchart showing a procedure of the main loop operation in the power standby state of the digital broadcast receiving apparatus 11.

When the digital broadcast receiving apparatus 11 becomes in the power standby state, the digital broadcast receiving apparatus 11 starts the main loop operation shown in FIG. 5 by control of the CPU 61.

When starting the main loop operation, the CPU 61 judges whether or not a power on demand exists (S1). If the power on demand exists, the CPU 61 terminates the main loop operation. If the power on demand does not exist, the CPU 61 proceeds to subsequent S2.

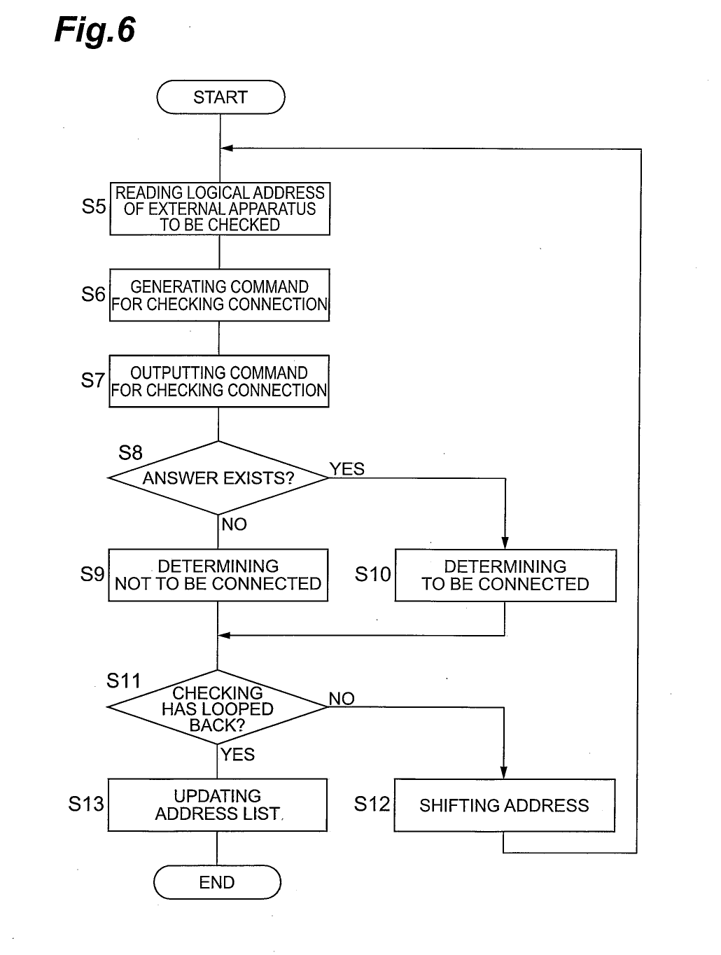

When proceeding to S2, the CPU 61 performs a later-described connection status checking operation along a flowchart shown in FIG. 6. Subsequently, the CPU 61 proceeds to S3, and after performing other control (for example, turning on of a standby LED of the liquid crystal display apparatus 14 and so on), the CPU 61 returns to S1 to repeatedly perform S1 to S3.

The CPU 61 performs the connection status checking operation along the flowchart shown in FIG. 6. Here, the connection status checking operation means an operation for checking a connection status of the external apparatus connected to the digital broadcast receiving apparatus 11 through the first HDMI terminal 23 or the second HDMI terminal 24, and is performed by the control of the CPU 61. As stated above, the embodiment assumes that the STB 35 and the HD DVD player 36 are the external apparatuses. FIG. 6 is a flowchart showing a procedure of the connection status checking operation in the digital broadcast receiving apparatus 11.

When the digital broadcast receiving apparatus 11 checks the connection status of the external apparatus through the CEC line 37b, the number of the objective external apparatuses is fourteen at a maximum. Fourteen is the number excluding television and broadcast based on a definition number of a logical address of HDMI-CEC. More specifically, three recording apparatuses, three reproducing apparatuses, three tuners, one AV-AMP and four others constitute the number fourteen.

When starting the connection status checking operation, the CPU 61 reads from the nonvolatile memory 64 the logical address of the external apparatus (in the embodiment, the STB 35 and the HD DVD player 36) whose connection status is to be checked (S5).

Next, the CPU 61 performs an operation as the command generating unit based on the read logical address to generate a command (check command) for checking the connection status of the external apparatus (S6). Subsequently, the CPU 61 proceeds to S7 and performs an operation as a command output unit to output the generated check command to the external apparatus (for example, the HD DVD player 36) to be checked.

Subsequently, the CPU 61 proceeds to S8 and performs an operation as the judging unit to judge whether or not the external apparatus (for example, the HD DVD player 36) to which the check command is outputted has answered (whether or not an answer command is received).

Here, if the external apparatus has not answered, the CPU 61 performs determination (disconnection determination) that the external apparatus is not connected (S9). When the external apparatus to which the check command is outputted answers, the CPU 61 performs determination (connection determination) that the external apparatus is connected (S10). The CPU 61 performs an operation as the connection determining unit in S9 and S10.

Further, the CPU 61 judges whether or not the checking for every external apparatus has ended (whether or not the checking has looped back) (S1). When the CPU 61 judges the checking for every external apparatus has ended, the CPU 61 proceeds to S13, and otherwise the CPU 61 proceeds to S12.

In S12, the CPU 61 shifts the logical addresses to be read and subsequently returns to S5 to repeat the above-described operation. In S13, the CPU performs an operation as the apparatus list update unit and updates a later-described address list (apparatus list) and thereafter terminates the connection status checking operation.

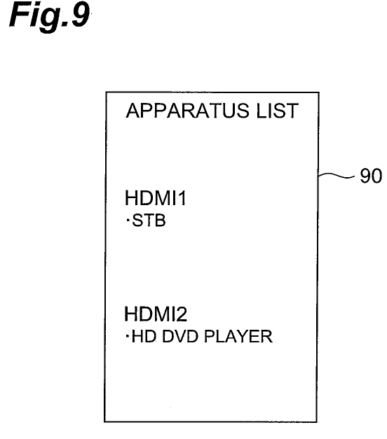

The address list here means a list of the external apparatuses connected to the digital broadcast receiving apparatus 11, and the address list is generated by the operation of the CPU 61 as the apparatus list generating unit. The digital broadcast receiving apparatus 11 makes the liquid crystal display apparatus 14 display an apparatus list 90 shown in FIG. 9, for example, as the address list. The apparatus list 90 displays the first HDMI terminal 23 and the second HDMI terminal 24, and the external apparatuses respectively connected thereto.

As stated above, the digital broadcast receiving apparatus 11 outputs the check command to the external apparatus through the first HDMI terminal 23 or the second HDMI terminal 24, and judges whether or not the external apparatus is connected based on a judgment result of whether or not the answer to the check command is received from the external apparatus.

Therefore, the digital broadcast receiving apparatus 11 can clarify the connection status of each external apparatus, such as which external apparatus is connected, which external apparatus is not connected, and whether or not the external apparatus connected before is disconnected from the digital broadcast receiving apparatus 11.

Some external apparatuses do not notify the digital broadcast receiving apparatus 11 of commands indicating that the external apparatuses are connected, although the external apparatuses are connected to the first HDMI terminal 23 and the second HDMI terminal 24 through the HDMI cable 37. However, as a result of the connection status checking operation by the digital broadcast receiving apparatus 11 as stated above, the connection status can be surely checked also for such external apparatuses, and a checking result thereof can be adequately reflected on the address list.

Further, if a user detaches the external apparatus from the first HDMI terminal 23, for example, the external apparatus cannot send back the answer, so that the digital broadcast receiving apparatus 11 judges that the external apparatus is not connected. Therefore, the connection status of the external apparatus coincides with the user's recognition.

Besides, since the address list is updated based on such a result of the connection status checking operation, the address list adequately reflects the connection status of the external apparatus at different times.

Furthermore, the digital broadcast receiving apparatus 11 performs the connection status checking operation in the power standby state.

If the digital broadcast receiving apparatus 11 tries to perform the connection status checking operation in a power on state, considering main processings (reception processing of the video signal, image signal processing, and so on) in the digital broadcast receiving apparatus 11, an entire processing load in the digital broadcast receiving apparatus 11 increases. Therefore, there is a possibility that the entire operation is delayed or reaction gets worse.

On the other hand, the processings of the digital broadcast receiving apparatus 11 in the power standby state require little processing loads, such as judging existence/nonexistence of the power on demand.

Thus, the digital broadcast receiving apparatus 11 performs the connection status checking operation in the power standby state. Hereby, the digital broadcast receiving apparatus 11 can perform the connection status checking operation without increasing the entire processing load.

Therefore, the digital broadcast receiving apparatus 11 does not suffer from delay of the entire operation or worse reaction even when the connection status checking operation is performed.

Meanwhile, when the connection status of the external apparatus is checked by the CPU 61, there can be considered several types in terms of the number of the external apparatuses checked at the same time and of the output cycle (period) of the check command. As for the check command, there can also be considered various commands.

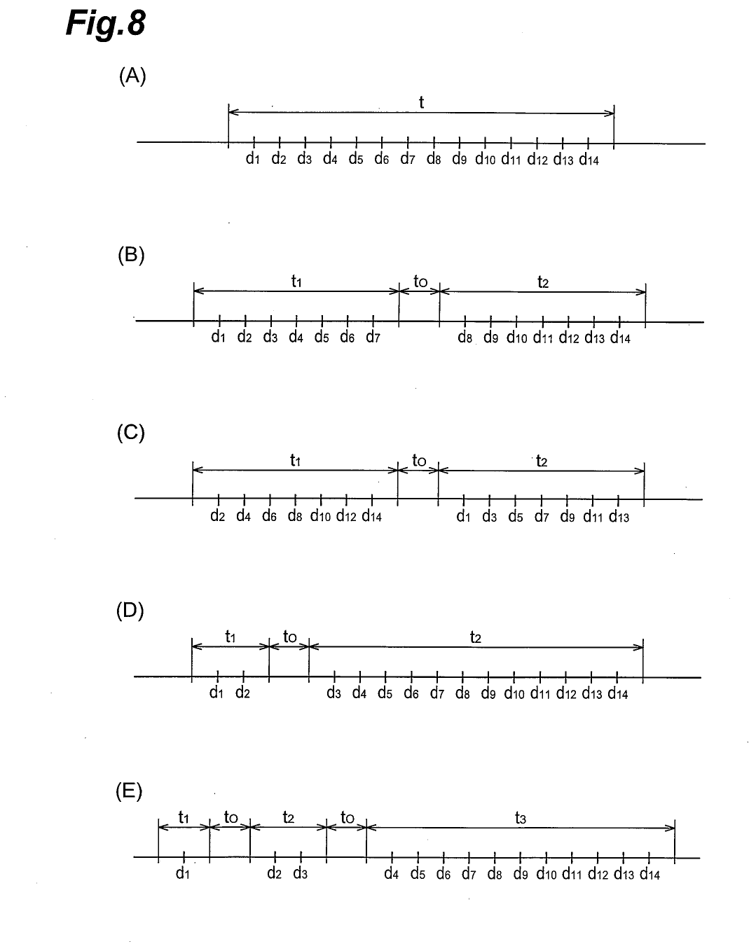

For example, as shown in FIG. 8(A), in one of the types, a time period (check time period t) for checking the connection status is set and the check commands are sequentially transmitted to all the external apparatuses d1, d2, d3 . . . d14 during the period t.

In another of the types, as shown in FIG. 8(B), check time periods t1, t2 are set so that a quiescent time period t0 is secured therebetween, check commands being sequentially transmitted to external apparatuses d1, d2 . . . d7 in a first half of logical addresses during the check time period t1, and check commands being sequentially transmitted to external apparatuses d8, d9 . . . d14 in a latter half of logical addresses during the check time period t2.

In still another one of the types, as shown in FIG. 8(C), check commands are sequentially transmitted to external apparatuses d2, d4, . . . d14 during a check time period t1, while check commands are sequentially transmitted to external apparatuses d1, d3, . . . d13 in a check time period t2. That is, check commands are sequentially transmitted to alternate external apparatuses during the check time period t1 and the check time period t2.

The number of the external apparatuses to which check commands are transmitted may be changed for check time periods t1 and t2, as shown in FIG. 8(D).

Yet another one of the types is possible, as shown in FIG. 8(E), in which check time periods t1, t2, t3 are set so that quiescent time periods t0 are secured therebetween, a check command being transmitted to an external apparatus d1 during the check time period t1, check commands being sequentially transmitted to external apparatuses d2, d3 during the check time periods t2, and check commands being sequentially transmitted to external apparatus d4, d5 . . . d14 during the check time period t3.

### MODIFICATION EXAMPLE

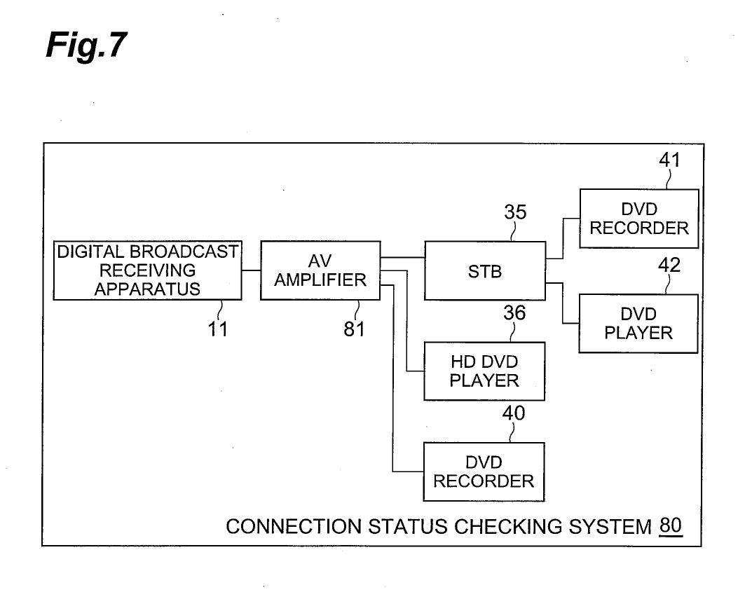

The invention is also applicable to a connection status checking system 80 shown in FIG. 7. The connection status checking system 80 includes an AV amplifier 81, and a digital broadcast receiving apparatus 11 is connected to an STB 35 and an HD DVD player 36 through the AV amplifier 81. Further, a DVD recorder 40 is connected to the AV amplifier 81 and a DVD recorder 41 and a DVD player 42 are connected to the STB 35.

In this case, external apparatuses of the digital broadcast receiving apparatus 11 are the AV amplifier 81, the STB 35, the HD DVD player 36, the DVD recorders 40, 41 and the DVD player 42. The DVD recorders 40, 41 employ DVDs (Digital Versatile Disks) as recording media, and record digital data to the recording media and read the recorded digital data to reproduce video and sound. The DVD player 42 employs a DVD as a recording medium, and reads digital data recorded in the recording media to reproduce video and sound.

In the case of the connection status checking system 10 stated above, the external apparatuses are the STB 35 and the HD DVD player 36, and each of the STB 35 and the HD DVD player 36 is connected to the digital broadcast receiving apparatus 11.

In the case of the connection status checking system 80, the digital broadcast receiving apparatus 11 is connected only to the AV amplifier 81 and other external apparatuses are not directly connected to the digital broadcast receiving apparatus 11. The STB 35 and the AV amplifier 81 may also be provided with terminals compliant with the HDMI standard. In such a case, a check command is transmitted to each external apparatus from the digital broadcast receiving apparatus through the AV amplifier 81 or the STB 35.

The STB 35 can be made able to perform a connection status checking apparatus similar to that of the digital broadcast receiving apparatus 11. In this case, the STB 35 transmits check commands to the DVD recorder 41 and the DVD player 42 as external apparatuses from a viewpoint of the STB 35, and judges whether or not the external apparatuses are connected based on judgment results of existence/nonexistence of answers to the check commands from those external apparatuses.

In the above embodiment, there is described an example of the case that power supply control is performed by using the command compliant with the HDMI-CEC standard, but the invention can be also realized by using a command compliant with another standard (for example AV-Link).

The description in the above is to describe the embodiments of the invention and, in no case, limits the apparatus and method of the invention, so that various modifications can be embodied with ease.

Further, the device and method structured by appropriately combining the components, the functions, the features or the steps of the method in the respective embodiments are also within the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A connection status checking apparatus checking a connection status of an external apparatus, comprising:
a connection part to which the external apparatus is connected;
a command output unit outputting a check command for checking whether or not the external apparatus is connected to said connection part;
a judging unit judging whether or not an answer to the check command from the external apparatus to which the check command is outputted by said command output unit exists; and
a connection determining unit determining whether or not the external apparatus is connected to said connection part based on a judgment result of said judging unit.

2. The connection status checking apparatus according to claim 1,
wherein said connection determining unit determines that the external apparatus is connected to said connection part when said judging unit judges that the answer is received and determines that the external apparatus is not connected to said connection part when said judging unit does not judge that the answer is received.

3. The connection status checking apparatus according to claim 1, further comprising
an operation control unit making said command output unit operate when a power source is made to be in a standby state.

4. The connection status checking apparatus according to claim 2, further comprising
an operation control unit making said command output unit operate when a power source is made to be in a standby state.

5. The connection status checking apparatus according to claim 3,
wherein said operation control unit makes said command output unit operate, assuming that the power source is made to be in the standby state, when a power on demand for making the power source in a power on state does not exist.

6. The connection status checking apparatus according to claim 1,
wherein said connection part is connected to a communication interface which performs communication in accordance with an HDMI-CEC standard, and
wherein said command output unit outputs the check command through the communication interface connected thereto.

7. The connection status checking apparatus according to claim 1, further comprising:
an apparatus list generating unit generating an apparatus list of the external apparatus connected to said connection part; and
an apparatus list update unit updating the apparatus list based on a determination result of said connection determining unit.

8. The connection status checking apparatus according to claim 1, further comprising:
an address storing device storing a logical address of the external apparatus connected to said connection part; and
a command generating unit reading the logical address stored in said address storing unit and generating the check command by using the read logical address,
wherein said command output unit outputs the check command generated by said command generating unit.

9. The connection status checking apparatus according to claim 1, further comprising:
a broadcast receiving device receiving a broadcast wave;
a video display device displaying video; and
a display control unit making said video display device display video by using data obtained from the broadcast wave received by said broadcast receiving device.

10. A connection status checking method for checking a connection status of an external apparatus, comprising:
outputting a check command for checking whether or not the external apparatus is connected;
judging whether or not an answer to the check command from the eternal apparatus to which the check command is outputted exists; and
determining whether or not the external apparatus is connected to a connection part based on a judgment result of the judging.
